(19) United States
(12) Patent Application Publication
(10) Pub. No.: US 2003/0179897 A1
(43) Pub. Date: Sep. 25, 2003

(54) Hearing aid device and components and related production process

(75) Inventor: Oleg Saltykov, Fairlawn, NJ (US)

Correspondence Address: Elsa Keller, Intellectual Property Department, Siemens Corporation, 186 Wood Avenue South, Iselin, NJ, 08830, US

(73) Assignee: Siemens Hearing Instruments, Inc.

(21) Appl. No.: 10/218,013

(22) Filed: Aug. 13, 2002

Related U.S. Application Data
(60) Provisional application No. 60/365,930, filed on Mar. 20, 2002.

(51) Int. Cl. H04R 25/00

(52) U.S. Cl. 381/328

(57) ABSTRACT

A hearing aid instrument and method of assembly are disclosed. The hearing aid comprises an electronic assembly which is useful in processing received sound to provide processed sound for output into an ear canal of a hearing aid user. The electronic assembly is placed within a chamber in a housing sized to fit within the ear of the hearing aid user. The chamber includes an internal guide channel and mounting surface for locating and positioning the electronic assembly. A volume encompassed within a hearing aid housing may be analyzed, such as with computer software, to identify a location within the chamber to position the electronic assembly, and then the electronic assembly may be incorporated into the housing using a guide channel and mounting surface of the housing for locating and positioning the electronic assembly in the identified location. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

This application claims priority to U.S. Provisional Application Serial No. 60/365,930 (Atty Dkt No. 2002P04645US) filed Mar. 20, 2002, entitled “Hearing Aid Instrument and Related Production Process.”

### FIELD OF THE INVENTION

The present invention relates to the field of hearing aids.

### BACKGROUND OF THE INVENTION

Hearings aids may be inserted either partially or completely into a user's ear canal. Typically, hearing aids, especially custom hearing aids, must be constructed to minimize feedback when deployed in the user's ear canal.

Existing construction methods and structures for custom hearing aids do not allow consistent feedback performance and typically require many iterations during manufacture to position an electronic assembly inside a housing of the hearing aid before a satisfactory performance is achieved, e.g. with respect to feedback.

Often, a closing procedure is done by a trial and error method with an assembly worker moving the electronic assembly within the housing chamber to try to achieve feedback-free operation. Such a procedure may take a significant amount of time. Further, there is no guarantee that the performance will be satisfactory, e.g. possible spikes on a frequency response may still exist because of internal feedback.

### SUMMARY OF THE INVENTION

A hearing aid instrument for positioning in the ear of a user comprises an electronic assembly which is useful in processing and providing processed sound for output into an ear canal of a hearing aid user when placed within a housing sized to fit within the ear of the hearing aid user. The housing includes an internal guide channel and a mounting surface for locating and positioning the electronic assembly.

The disclosed construction and assembly method of the hearing aid instrument provides for consistent results when assembling the hearing aid instrument. A volume, e.g. a chamber, encompassed within the hearing aid housing may be analyzed, such as with computer software, to identify a location within the chamber to position the electronic assembly, and then the electronic assembly may be incorporated into the housing using a guide channel and mounting surface of the housing for locating and positioning the electronic assembly in the identified location.

The scope of protection is not limited by the summary of an exemplary embodiment set out above, but is only limited by the claims.

### BRIEF DESCRIPTION OF THE DRAWINGS

The features, aspects, and advantages of the present invention will become more fully apparent from the following description, appended claims, and accompanying drawings in which:

FIG. 1 is a plan view of an exemplary embodiment of boot tube of the present invention;

FIG. 2 is a partial cutaway view in partial perspective of an exemplary embodiment of a hearing aid instrument showing a boot tube partially inserted into a hearing aid shell;

FIG. 3 is a plan view in perspective of an end of an exemplary embodiment of a hearing aid instrument showing a channel guide;

FIG. 4 is a partial cutaway view in partial perspective of an exemplary embodiment of a hearing aid instrument showing a boot tube more fully inserted into a hearing aid shell; and

FIG. 5 is a flowchart of an exemplary method of manufacturing an exemplary embodiment of a hearing aid instrument.

### DETAILED DESCRIPTION OF THE PREFERRED EMBODIMENT

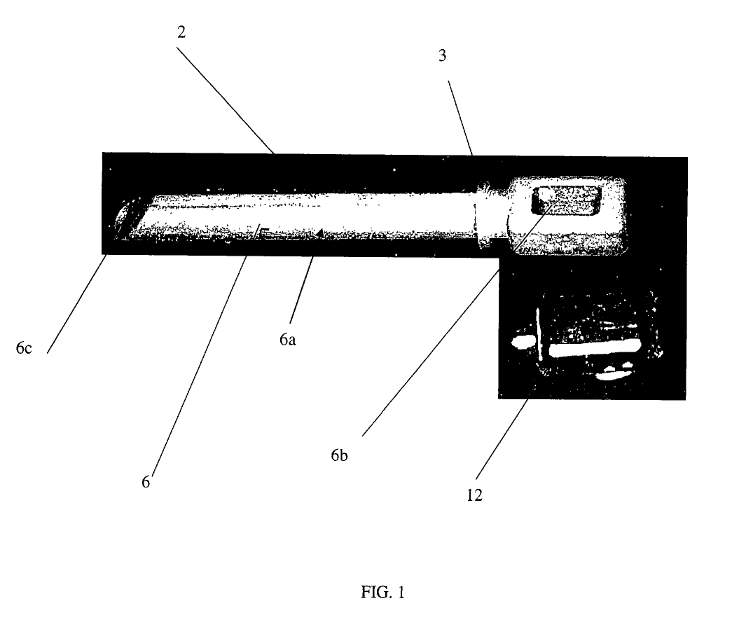

Referring now to FIG. 1, boot tube 6 comprises a substantially tubular pathway 6a and assembly receptacle 6b. In a currently preferred embodiment, assembly receptacle 6b is in fluid communication with tubular pathway 6a. Assembly receptacle 6b is sized to receive electronic assembly 12.

Electronic assembly 12 comprises components which process received sound to provide processed sound for output into an ear canal of a hearing aid user, e.g. a receiver. In a preferred embodiment, electronic assembly 12 is an electromechanical receiver as will be familiar to those of ordinary skill in the hearing aid arts. In alternative embodiments, electronic assembly 12 may further comprise additional electronic components such as filters; active devices, and the like.

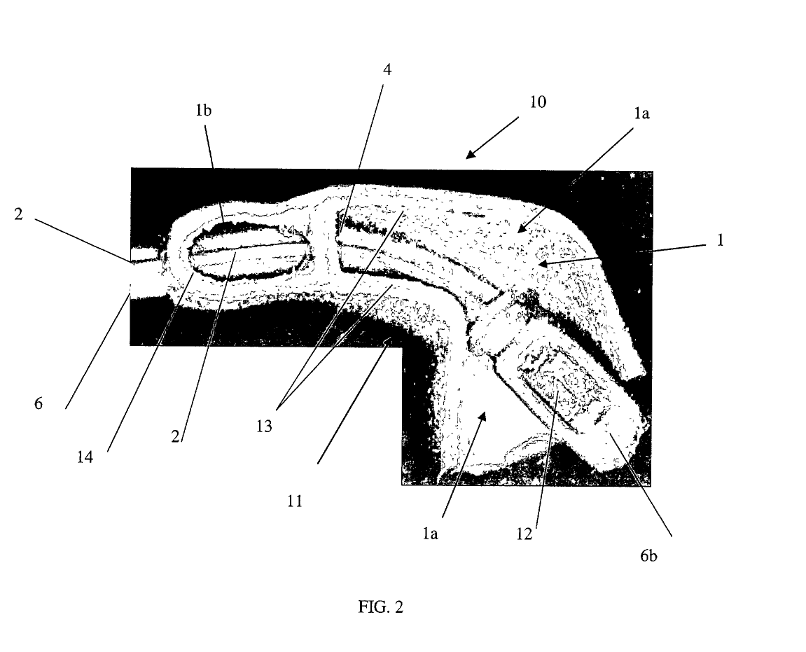

Barrier stopper 3 is located at a predetermined position along an exterior portion of tubular pathway 6a. In a preferred embodiment, barrier stopper 3 is a ring shaped stopper which is integral with an outer portion of tubular pathway 6a. In alternative embodiments, barrier stopper 3 may be a component that is separate from tubular pathway 6a and can be mounted or otherwise attached to tubular pathway 6a at a predetermined position along tubular pathway 6a such as prior to insertion of boot tube 6 and electronic assembly 12 within chamber 1 (FIG. 2).

Additionally, key ridge 2 is present along a predetermined length of tubular pathway 6a. In a preferred embodiment, key ridge 2 is a ridge or elevation formed in a predetermined portion of boot tube 6 such as along an outside portion of tubular pathway 6.

Referring now to FIG. 2, hearing aid 10 comprises housing 111 into which boot tube 6 and electronic assembly 12 may be placed.

Housing 11 further comprises chamber 1. Inner surfaces 13 of chamber 1 are sized to receive boot tube 6, including assembly receptacle 6b.

Barrier 4, e.g. a shoulder or ridge within chamber 1, is disposed within a predetermined portion of chamber 1 proximate distal end 14 of chamber 1. Barrier 4 separates chamber 1 into two sections, 1a and 1b. An aperture (not shown in the figures) in barrier 4 allows communication between sections 1a and 1b and permits boot tube 6 to be placed through barrier 4 from chamber 1a through to chamber 1b. In a currently envisioned alternative embodiment, either or both of chambers 1a and 1b may be at least partially filled with a predetermined filler material.

One or both of sections 1a and 1b of chamber 1 further define a parking space which can be used in locating and positioning boot tube 6 and electronic assembly 12 within chamber 1. Movement of boot tube 6 and electronic assembly 12 within the parking space, e.g. as defined by chamber 1a, is impeded by barrier 4.

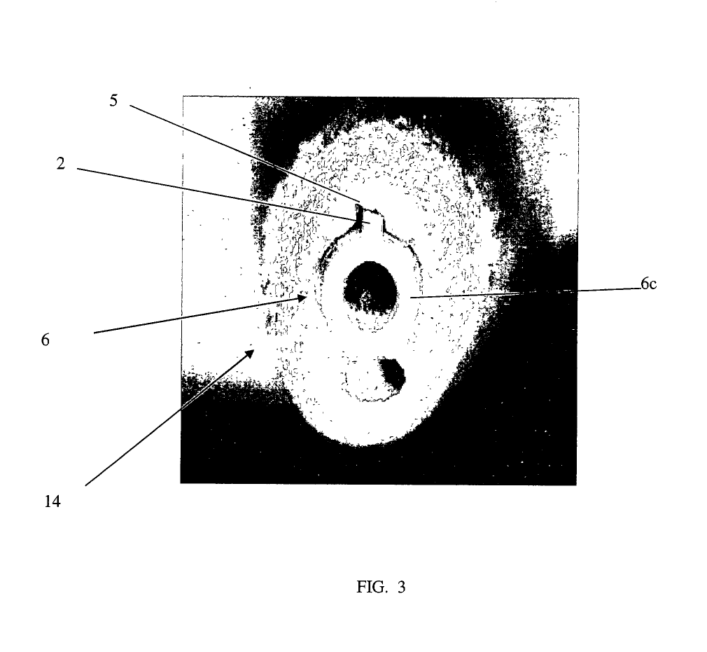

Referring now to FIG. 3, guide channel 5 is present along a predetermined section of chamber 1 (FIG. 2) along a predetermined portion of inner surface 13 (FIG. 2). Guide channel 5 is adapted to accept key ridge 2 for positioning boot tube 6 within chamber 1, e.g. within sections 1a and 1b (FIG. 2). Further, key ridge 2 may be used to limit the amount of turning boot tube 6 or electronic assembly 12 (FIG. 2) are permitted when boot tube 6 and electronic assembly 12 are inserted into chamber 1.

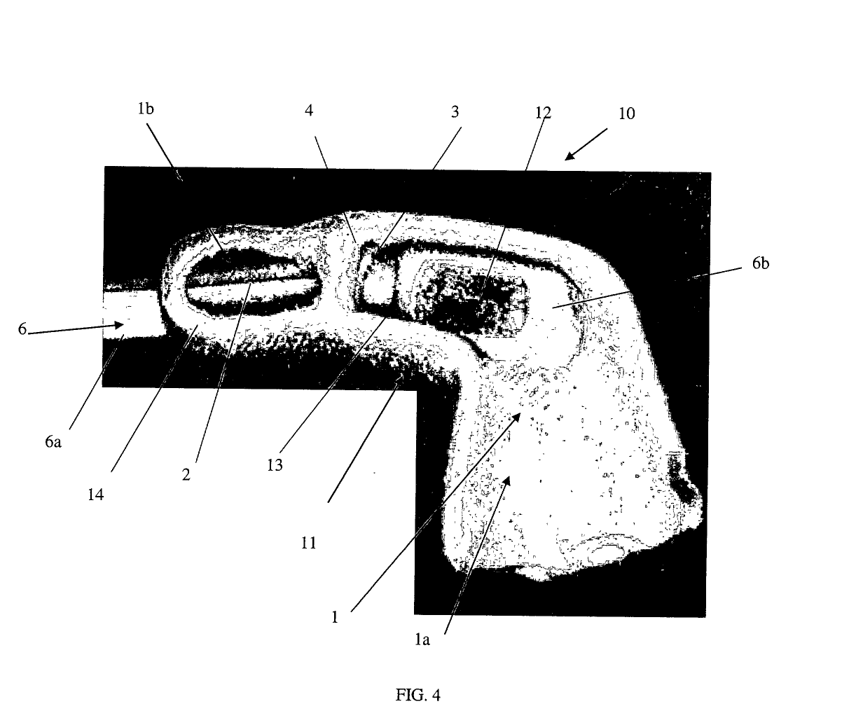

Referring now to FIG. 4, once inserted into chamber 1, boot tube 6 may be guided within chamber 1 such as by mating key ridge 2 and guide channel 5 (FIG. 3). When boot tube 6 is drawn into chamber 1, its progress into chamber 1 will be impeded by barrier stopper 3 contacting barrier 4 when assembly receptacle 6b reaches a predetermined position within chamber 1, e.g. within section 1a at a predetermined distance from barrier 4.

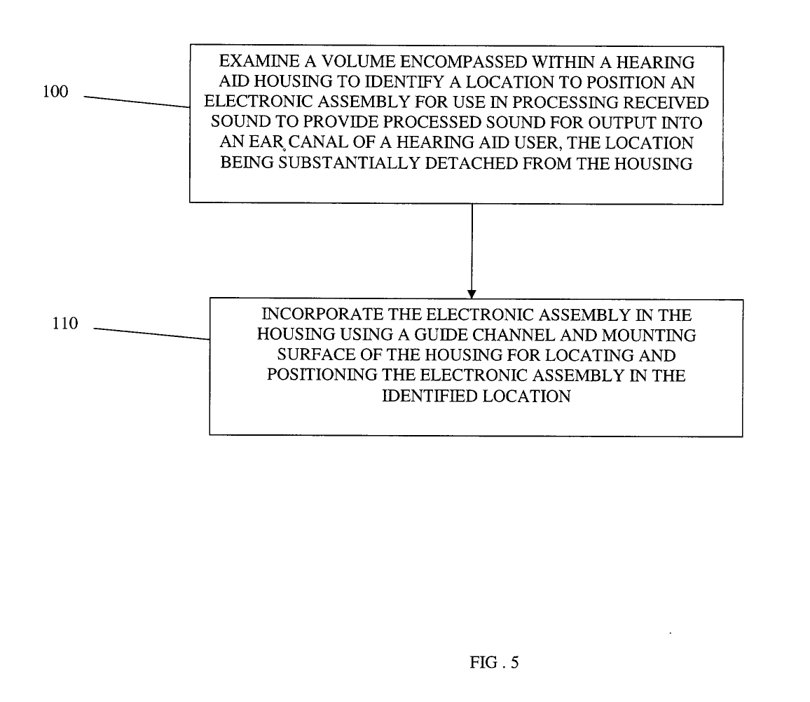

In the operation of an exemplary embodiment, referring now to FIG. 5, spacing within housing 11 (FIG. 2), such as the volume defined by inner surfaces 13 (FIG. 2) of chamber 1 (FIG. 2), may be examined, step 100, and analyzed, e.g. with software, to create a desired dimension with respect to chamber 1 (FIG. 2) and assembly receptacle 6b (FIG. 1) which will contain electronic assembly 12 (FIG. 1) such as to achieve a desired audio quality. Dimensions of chamber 1, e.g. characteristics of inner surfaces 13 (FIG. 2) and placement of barrier 4 (FIG. 2) to form sections 1a and 1b (FIG. 2), may then be determined for a desired positioning of electronic assembly 12 (FIG. 1) by providing required gaps between inner surfaces 13 of chamber 1 and an outside surface of assembly receptacle 6b (FIG. 1). These dimensions may also include characteristics of barrier 4 (FIG. 2), e.g. an offset from distal end 14 (FIG. 2) to an edge of barrier 4 which will contact barrier stopper 3 (FIG. 1). Desired positioning may be an optimum positioning, based on predetermined criteria.

Guide channel 5 (FIG. 3) may also be formed or otherwise manufactured in chamber 1 (FIG. 2) and/or barrier 4 (FIG. 2) to aid in providing a desired positioning of assembly receptacle 6b (FIG. 1) in chamber 1.

When hearing aid 10 (FIG. 2) is to be assembled, electronic assembly 12 (FIG. 1) may be delivered into and incorporated into assembly receptacle 6b (FIG. 1) of chamber 1 (FIG. 1), step 110. In a preferred embodiment, electronic assembly 12 is placed into assembly receptacle 6b. Tubular pathway 6a (FIG. 1) and assembly receptacle 6b (FIG. 1) may be manufactured with barrier stopper 3 formed as part of or integral with tubular pathway 6a at a predetermined offset from assembly receptacle 6b (FIG. 1). Alternatively, if not already integral with tubular pathway 6a (FIG. 1), prior to delivering electronic assembly 12 into chamber 1, barrier stopper 3 (FIG. 1) may be added to tubular pathway 6a at a predetermined offset from assembly receptacle 6b (FIG. 1).

Once electronic assembly 12 (FIG. 1) is positioned within assembly receptacle 6b, insertion end 6c (FIG. 1) of boot tube 6 (FIG. 1) is maneuvered into chamber 1 (FIG. 4) such as with a device puller. Key ridge 2 (FIG. 1) is mated with guide channel 5 (FIG. 3) and boot tube 6 drawn into chamber 1 (FIG. 4) until barrier stopper 3 (FIG. 4) reaches a predetermined position inside chamber 1 (FIG. 4) such as against barrier 4 (FIG. 4).

After delivering boot tube 6 (FIG. 1) and electronics assembly 12 (FIG. 1) into chamber 1 (FIG. 2), additional required components may be added, e.g. a battery, battery contacts, additional electronics, a battery door, and the like, or combinations thereof. Housing 11 (FIG. 2) may then be closed.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1) A boot tube for use in a hearing aid, comprising:
a. a substantially tubular pathway having a distal end;
b. an assembly receptacle, adapted to receive an electronics assembly, disposed at an end of the tubular pathway opposite the distal end, the assembly receptacle in fluid communication with the tubular portion; and
c. a key ridge disposed about a predetermined length of an outside of the tubular pathway.

2) A boot tube according to claim 1, further comprising:
a. a barrier stopper disposed about the outside of the tubular pathway at a predetermined offset from the assembly receptacle.

3) A boot tube according to claim 2, wherein:
a. the barrier stopper comprises at least one of (i) a stopper ring, (ii) an elevation integral with a predetermined linear portion of the outside of the tubular pathway, and (iii) an elevation integral with a predetermined portion of a circumference of the outside of the tubular pathway.

4) A hearing aid instrument for positioning in the ear of a user, comprising:
a. an electronic assembly for use in processing received sound to provide processed sound for output into an ear canal of a hearing aid user; and
b. a housing being sized to fit within an ear of a hearing aid user and for containing the electronic assembly, the housing comprising a chamber, the chamber comprising an internal guide channel and parking space for locating and positioning the electronic assembly within the chamber.

5) A hearing aid instrument according to claim 4, wherein:
a. the guide channel and parking space position the electronic assembly substantially out of contact with an inner surface of the chamber.

6) A hearing aid instrument according to claim 4, further comprising:
a. a barrier stopper disposed between the parking space and the electronic assembly for separating the electronic assembly from the parking space.

7) A hearing aid instrument according to claim 6, wherein:
a. the barrier stopper comprises at least one of (i) a stopper ring disposed at a predetermined offset from the electronics assembly about an outer portion of a boot tube and (ii) an elevation integral with a boot tube disposed at a predetermined offset from the electronics assembly about an outer portion of the boot tube.

8) A hearing aid instrument according to claim 4, wherein:
a. the parking space comprises a barrier formed in the housing, the barrier separating the chamber into a plurality of sections, the barrier further comprising an aperture through which a predetermined portion of a boot tube may be admitted.

9) A hearing aid instrument according to claim 8, wherein:
a. at least one of the sections is at least partially filled with a predetermined filler material.

10) A hearing aid instrument according to claim 4, wherein:
a. the guide channel accommodates a locating key ridge attached to a boot tube into which the electronic assembly has been placed for positioning the electronic assembly within the chamber.

11) A hearing aid instrument for positioning in the ear of a user, comprising:
a. a boot tube comprising:
i. a substantially tubular pathway;
ii. a key ridge disposed about a predetermine portion of an outer surface of the tubular pathway; and
iii. an assembly receptacle adapted to receive an electronic assembly, the assembly receptacle in fluid communication with the tubular pathway;
b. an electronic assembly for use in processing received sound to provide processed sound for output into an ear canal of a hearing aid user, the electronic assembly disposed at least partially within the assembly receptacle; and
c. a housing adapted to fit within an ear of a hearing aid user, the housing further comprising:
i. a chamber adapted to receive and contain the boot tube;
ii. an internal guide channel in communication with a predetermined portion of the chamber, the internal guide channel adapted to receive the key ridge; and
iii. a barrier at a predetermined end of the chamber, the barrier adapted to prevent movement of the boot tube along a predetermined axis of the chamber.

12) A method for producing a hearing aid instrument for positioning in the ear of a user, comprising:
a. examining a volume encompassed within a hearing aid housing to identify a location to position an electronic assembly for use in processing received sound to provide processed sound for output into an ear canal of a hearing aid user, the location being substantially detached from the housing; and
b. incorporating the electronic assembly in the housing using a guide channel and mounting surface of the housing for locating and positioning the electronic assembly in the identified location.

13) A method according to claim 12, including the step of:
a. providing a barrier stopper between the housing mounting surface and the electronic assembly for separating the assembly from the housing mounting surface.

14) A method according to claim 13, further comprising:
a. determining a dimension of the barrier stopper according to a predetermined positioning criterion;
b. selecting barrier stopper satisfying the determined dimension; and
c. placing the barrier stopper at a predetermined position relative to the electronic assembly prior to inserting the electronic assembly into the hearing aid housing.

15) A method according to claim 14, further comprising:
a. prior to inserting the electronic assembly into the hearing aid housing, placing the barrier stopper about at least one of (i) a predetermined portion of a tube boot of the electronic assembly and (ii) a predetermined portion of an outer surface of the electronic assembly.
